(19) United States
(12) Patent Application Publication
(10) Pub. No.: US 2007/0203709 A1
(43) Pub. Date: Aug. 30, 2007

(54) Voice dialogue apparatus, voice dialogue method, and voice dialogue program

(75) Inventor: Shindoh Yasutaka, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/527,503

(22) Filed: Sep. 27, 2006

(30) Foreign Application Priority Data
Feb. 28, 2006 (JP) 2006-051771

(51) Int. Cl. G10L 21/00

(52) U.S. Cl. 704/275

(57) ABSTRACT

Keywords are enumerated preliminarily by an dialogue apparatus. The keywords are enumerated again after a pause for requesting a person to make a choice. If there is any effective choice, the scenario proceeds in accordance with the choice. If there is no effective choice, the keywords are enumerated again. If all the keywords are negated, the routine proceeds to the process of another scene.

### TECHNICAL FIELD

The present invention relates to voice dialogue between a person and an information processing apparatus. In particular, the present invention relates to a technique for allowing a person to easily answer the question in a scenario stored in the apparatus in advance for the purpose of guidance or the like.

### BACKGROUND ART

In some cases, a voice dialogue apparatus enumerates a large number of keywords to a person for asking the person to make a choice. In such cases, if the keywords are simply enumerated, the person may fail to hear the individual keywords. Therefore, for easier understanding of the keywords, pauses may be inserted between the keywords (see Japanese Laid-Open Patent Publication No. 11-288292). However, in this case, since it is necessary to determine the respective lengths of pauses, creation of the scenario becomes difficult.

### SUMMARY OF THE INVENTION

An object of the present invention is to provide a technique in which at the time of enumerating a large number of keywords to a person by voice, the person can easily hear the keyword, and make the best choice.

Another object of the present invention is to provide a technique for preventing voice dialogue from becoming monotonous, and redundant by repetition of keywords, and allowing a person to answer easily.

Still another object of the present invention is to provide a technique for allowing a person to answer before the second enumeration of the keywords is finished.

According to the present invention, a voice dialogue apparatus comprises a microphone for allowing voice input from a person; a voice recognition apparatus for recognizing the voice input to the microphone; a voice output apparatus having a speaker; a memory for storing a scenario; and a processing system for controlling the voice recognition apparatus and the voice output apparatus in accordance with the scenario, wherein the scenario stored in the memory is configured such that, at the time of outputting voice from the speaker for enumerating a plurality of keywords, first enumerating the keywords, and then, enumerating the keywords next, pausing the voice output, again for receiving the voice input of the person.

Preferably, the scenario is further configured such that, when enumerating the keywords again, the keywords is enumerated in the same order as in the first enumeration, with converting at least one of the keywords into a synonymous term.

Further, preferably, the voice recognition apparatus is further configured such that the voice input from the person in response to the enumerated keywords is at the latest processed from when the keyword being again enumerated by the voice recognition apparatus.

According to the present invention, A voice dialogue method carries out the steps of: receiving voice input of a person from a microphone; performing voice recognition of the voice input by a voice recognition apparatus; and controlling the voice recognition apparatus and a voice output apparatus by a processing system, wherein after a plurality of keywords are enumerated from a speaker, the voice output is paused, and then, the plurality of keywords are enumerated again, and the voice input of the person is recognized by the voice recognition apparatus.

According to the present invention, a voice dialogue program carries out the steps of: receiving voice input of a person from a microphone; performing voice recognition of the voice input by a voice recognition apparatus; and controlling the voice recognition apparatus and a voice output apparatus by a processing system. The voice dialogue program comprises: an instruction for enumerating a plurality of keywords from a speaker as a voice output; an instruction for pausing the voice output; an instruction for enumerating the keywords again; and an instruction for recognizing the voice input of the person by the voice recognition apparatus at least at the time of enumerating the keywords again.

In the specification, the description about the voice dialogue apparatus applies as it is to the voice dialogue method and the voice dialogue program. Further, the description about the voice dialogue method applies as it is to the voice dialogue apparatus or the voice dialogue program.

For example, the answer of the person to the enumeration of the keywords is a choice from the keywords.

In the present invention, at the time of first requesting an answer by enumerating a plurality of keywords, the keywords are enumerated, a pause is inserted in the voice output, and then, the keywords are enumerated again. Even if the person misses the keywords in the first enumeration, the person can hear the keywords correctly in the next enumeration, and make an answer. Since the pause is inserted between the first enumeration and the next enumeration, when the next enumeration is stared, the person can immediately understand that the same keywords are repeated. Further, it is sufficient that the user roughly understands the group of keywords in the first enumeration. The user can make an answer when the keywords are outputted again. Thus, the answer can be made correctly. In scenario creation, it is not necessary to use different pause lengths. Thus, the pause can be set simply.

In the second enumeration, if the keywords are outputted with conversion into synonymous terms, the dialogue does not become monotonous. If the order of the keywords does not change from the first enumeration in the second numeration, the person can make an answer easily.

At the time of the second enumeration of the keywords, since the person is almost ready for making the answer, by carrying out voice recognition of the answer while outputting the keywords, even if the person make the answer immediately after hearing the keywords, the voice input can be accepted.

### BRIEF DESCRIPTION OF THE DRAWINGS

FIG. 1 is a block diagram showing a voice dialogue apparatus according to an embodiment.

FIG. 2 is a block diagram showing a scenario used in the embodiment.

FIG. 3 is a diagram showing a register for voice recognition according to the embodiment.

FIG. 4 is a flowchart showing a voice dialogue method according to the embodiment.

FIG. 5 is a block diagram showing a voice dialogue program according to the embodiment.

FIG. 6 is a flowchart showing an example in which the embodiment is applied in department guidance in a university.

Brief Description of Symbols

| | | | |
|---|---|---|---|
| 2 | voice dialogue apparatus | | |
| 4 | microphone | 6, 32 | amplifier |
| 8 | voice recognition apparatus | | |
| 10 | dictionary | 12 | register |
| 14 | processing system | 16 | scenario memory |
| 18 | general scenario | | |
| 20 | keyword enumeration scenario | | |
| 21 | first keyword enumeration scene | | |
| 22 | pause scene | | |
| 23 | second keyword enumeration scene | | |
| 24 | pause scene | 25 | prompt scene |
| 26 | input reception scene | 30 | voice data generator |
| 34 | speaker | 36 | robot body |
| 40 | voice dialogue program | | |
| 41 | instructions for general scenario | | |
| 42 | instructions for keyword enumeration | | |
| 43 | instructions for keyword re-enumeration | | |
| 44 | instructions for pause | | |
| 45 | instructions for voice recognition | | |
| 46 | instructions for prompt | | |

### EMBODIMENT

Hereinafter, an embodiment in the most preferred form for carrying out the present invention will be described. In the drawings, a reference numeral 2 denotes a voice dialogue apparatus, a reference numeral 4 denotes a microphone for voice input, and a reference numeral 6 denotes an amplifier. The amplifier 6 may not be provided. A reference numeral 8 denotes a voice recognition apparatus, and a reference numeral 10 denotes a dictionary. In practice, a plurality of dictionaries 10 are stored in the dialogue apparatus 2. A reference numeral 12 denotes a register for outputting a recognition result, a reference numeral 14 denotes a processing system, and a reference numeral 16 denotes a scenario memory for voice dialogue. The scenario includes scenes, and a memory position in each scene is referred to as the address.

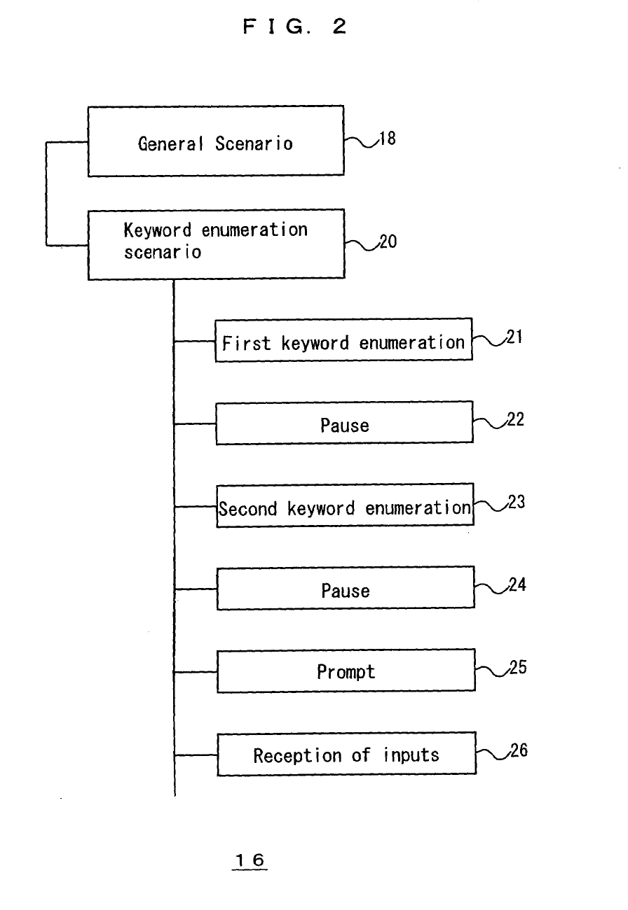

FIG. 2 shows structure of a scenario stored in the scenario memory 16. A general scenario 18 is portion of the scenario other than the portion for enumerating keywords. A keyword enumeration scenario 20 is the portion of the scenario for enumerating keywords. Enumeration of the keywords herein means enumeration of two or more keywords. Preferably, three or more keywords are enumerated. In a first keyword enumeration scene 21, the keywords are enumerated for the first time, and in a pause scene 22, a pause is inserted temporarily. In a second keyword enumeration scene 23, the keywords are enumerated again. In a pause scene 24, a pause is inserted after the second keyword enumeration. In a prompt scene 25, a person is prompted to input after the second pause. The scenario includes an output scenario on the voice output side and an input scenario on the voice input side. The output scenario and the input scenario proceed synchronously. The scenes 21 to 25 are included in the output scenario. In the input scenario on the voice input side, the choice inputted by the person in response to the enumerated keywords is received in an input reception scene 26 for voice recognition. The voice recognition of the enumerated keywords is started, e.g., from the first keyword enumeration scene 21, the pause scene 22, or the second keyword enumeration scene 23. In correspondence with the choice, switching of the dictionary 10 corresponding to the enumerated keywords is performed, and the register 12 is cleared to zero before recognition.

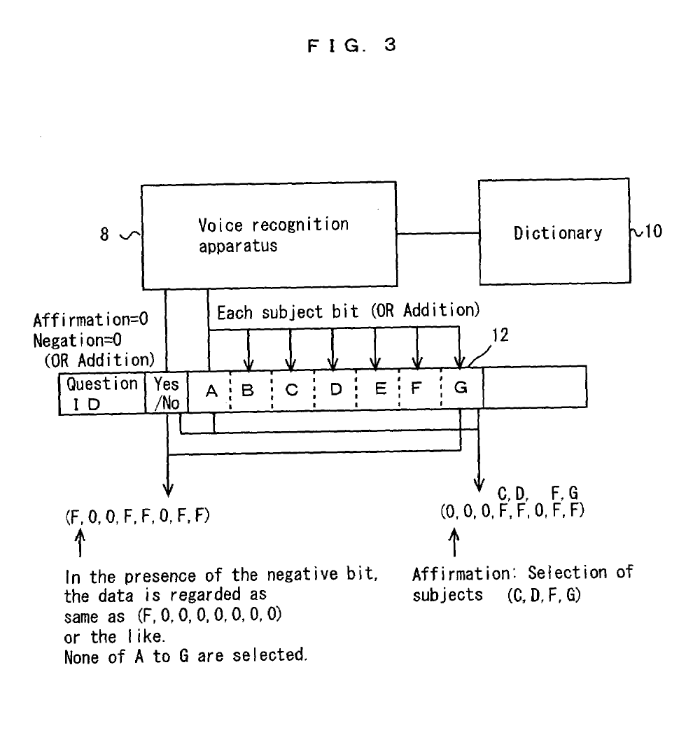

FIG. 3 shows structure of the register 12. In FIG. 3, seven keywords A to G are enumerated for prompting a person to make a choice from the keywords. Effective answers are selection of at least one keyword, and negation of all the choices such as “I don't need at all” or “I don't need”. A question ID is written in the register 12. The question ID indicates a scene in input scenario. The next one bit indicates whether the answer is affirmation or negation. The bit “0” indicates affirmation, and the bit “F” indicates negation. Each keyword has synonymous terms. For example, in the case of department guidance in a university, “engineering department”, “engineering dept”, and “engineering” are synonymous terms”. Assuming that structure obtained by abstraction of the synonymous terms as a whole is referred to as the subject, the answer of the person is regarded as the choice of the subject. In the register 12 of FIG. 3, one bit is assigned to each of seven subjects A to G. The number of subjects changes depending on the question. From the bit next to the affirmative/negative bit, one bit is assigned to each subject. The register 12 should have a sufficiently large storage capacity.

A plurality of registers 12 may be provided in preparation for the answer as combination of affirmation and negation such as “I don't need A, but I need B”. In this case, “I don't need A” is processed by the register in the first stage, and “I need B” is processed by the register in the next stage. Further, it is not required to store one bit data for representing affirmation/negation or choice of the subject. Alternatively, data having the larger bit length may be stored for this purpose.

The dictionary 10 stores keywords to be enumerated, synonymous terms of the keywords, words indicating the scope or combination of keywords, and words indicating affirmation/negation. For example, the words “all” and “every” indicate the scope or combination of keywords. The words “science and engineering” indicate the combination of “science” and “engineering”. The word “arts” indicates the combination of literature department, economics department, and business and commerce department”. These keywords and synonymous terms are switched by changing the dictionary in each scene of the input scenario. The words “yes”, “please” indicate affirmation, and the words “no” or “not” indicate negation. If no word indicating affirmation or negation is inputted, the affirmative/negative bit remains to have an initial value indicating affirmation.

If any word written in the dictionary 10 is present in the voice input, the voice recognition apparatus 8 writes a bit corresponding to the word in the register 12. If the word indicates affirmation or negation, “0” or “F” is outputted for the affirmative/negative bit. The bit of each subject corresponding to the word indicating affirmation/negation is set to “F”. Further, if any keyword corresponding to the group of subjects is found, the bits of subjects included in the group are set to “F”. Then, each time the voice recognition apparatus 8 finds a keyword, data is written in the register 12 by OR addition. For example, if an answer “Literature please.” is inputted in department guidance in a university, “literature” is detected as a keyword, and the bit of the subject corresponding to the keyword is set to “F”. The other bits remain “0”. Further, since “please” corresponds to affirmation, the affirmative bit at the head is kept at “0”, and the values of the other bits are not changed. In this case, the affirmative bit is set to “0”, and the output is affirmative. Since the bit of “literature” is set, and the other bits are not set, only the guidance of literature is requested. In the case of “literature and economics, please”, the bit of “literature” and the bit of “economics” are set, and the affirmative/negative bit remains “0” indicating affirmation.

According to a special rule for recognizing a choice from the enumerated keywords, in the case of input without specifying keywords such as “yes” and “it”, it is determined that the keyword outputted immediately before the input is selected with affirmation. Though the rule is provided in preparation for the input of “yes” or the like in the middle of the second keyword enumeration, it is not essential to provide this rule. Further, for the input including two or more words of affirmative/negative structures such as “I don't need literature, but I want to know economics”, a plurality of registers 12 may be provided. In this case, in the register of the first stage, for “I don't need literature”, the value of the affirmative/negative bit is set to “F” indicating negation, and the bit of “literature” is set to “F”. In the register of the next stage, “I want to know economics” is processed. That is, the affirmative/negative bit is set to “0” indicating affirmation, and the bit of “economics” is set to “F”. The recognition result of this case is same as that in the case of “I want to know about the economics department”.

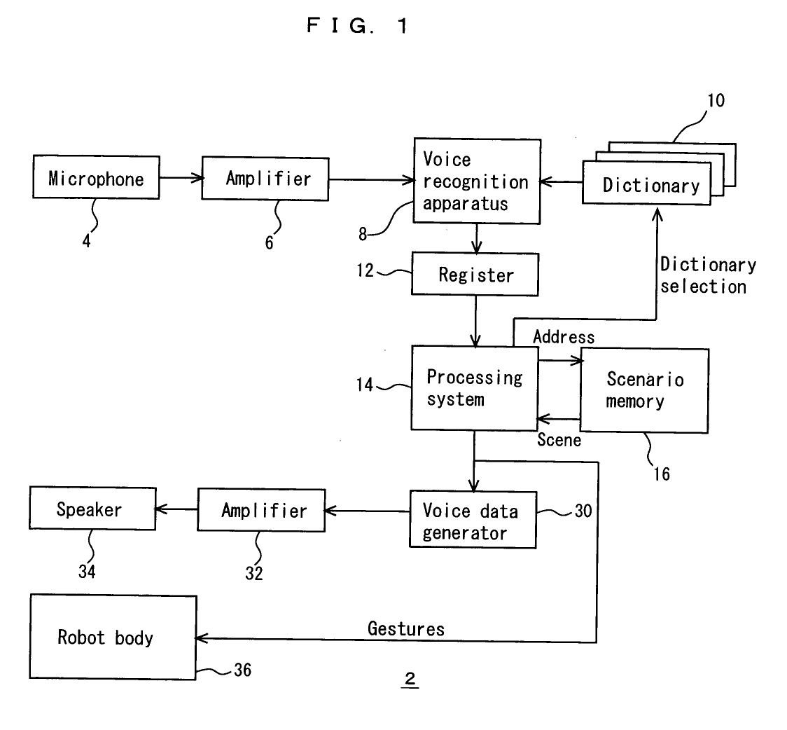

Referring back to FIG. 1, the voice data generator 30 generates voice based on the scenario, and outputs the voice from the speaker 34 through the amplifier 32. The amplifier 32 may not be provided. In the embodiment, the voice dialogue apparatus 2 is incorporated in a robot for providing guidance. By a gesture signal from the processing system 14, a robot body 36 is operated.

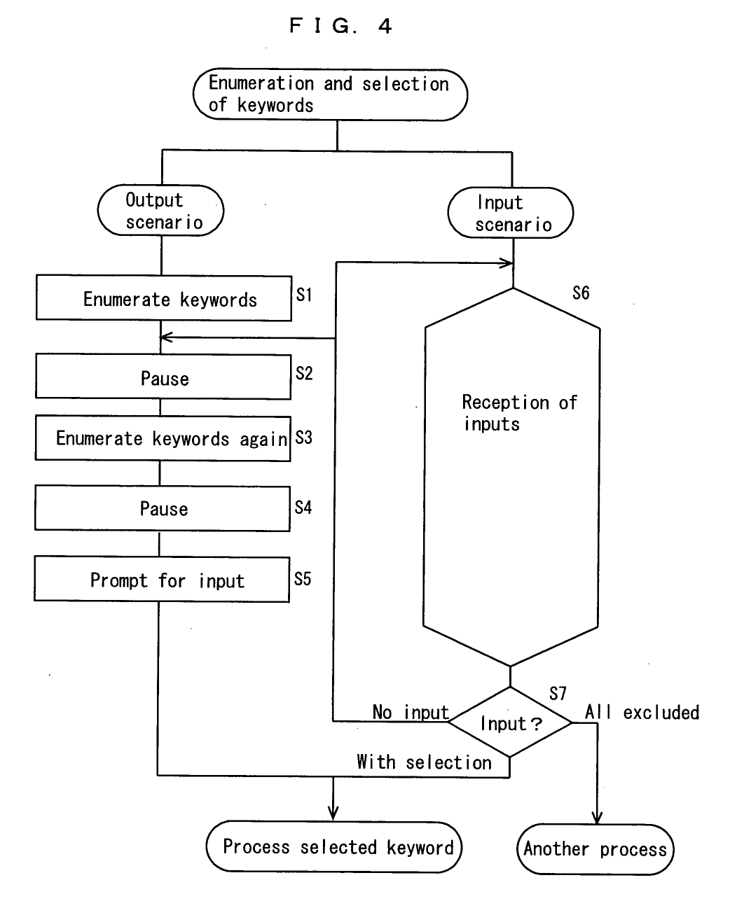

FIG. 4 shows a voice dialogue method according to the embodiment. In the process of enumerating keywords in the scenario, and selecting a keyword from the enumerated keywords, in the output scenario, in step 1, the keywords are enumerated. Then, in step 2, a pause is inserted. In step 3, the keywords are enumerated again. In step 4, a pause is inserted, and then, in step 5, the user's input is prompted. The pause in step 4 may be omitted. In the case of the embodiment, in step 2 or in step 4, gestures of the robot body 36 may be used. Further, at the time of enumerating the keywords again in step 3, if some of the keywords enumerated in step 1 are converted into synonymous terms, in particular, into simple words, and the words are enumerated in the same order, since the expressions in the first keyword enumeration and second keyword enumeration are different, but in the same order, the person can answer easily, and redundancy is reduced.

In the input scenario, from enumeration of the keywords in step 1, the input is received (accepted), and voice recognition of the voice input is carried out. Sound recognition of the voice input may be stared from the pause in step 2 or the second keyword enumeration in step 3. In step 7, the input result is determined. In the absence of effective input, the routine returns to the pause in step 2 or the second keyword enumeration in step 3, or carries out a process of repeating enumeration of the keywords or the like for receiving the input again. If all the choices are negated, the routine proceeds to another process. If one or more keyword is selected, guidance is provided for the selected keyword or combination of the selected keywords.

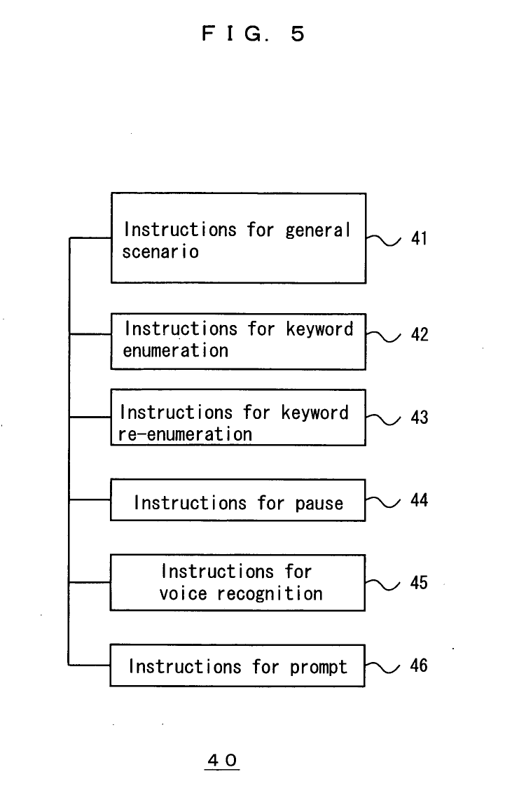

FIG. 5 shows structure of the voice dialogue program 40. Instructions 41 for general scenario process portion of the scenario that is not used for keyword enumeration. Instructions 43 for keyword re-enumeration process the second keyword enumeration. Instructions 44 for pause process a pause or gestures between the first keyword enumeration and the second keyword enumeration, and after the second keyword enumeration. Instructions 45 for voice recognition start voice recognition, e.g., from the middle of the first keyword enumeration, and switches the dictionary 10 in correspondence with the keywords. Based on the recognition result of the voice input, the instructions 45 branch the scenario to return to the process before recognition in the scenario, to proceed to another process, or to provide guidance about the selected keyword. Instructions 46 for prompt output a sentence for prompting the person to input after the second keyword enumeration and the second pause.

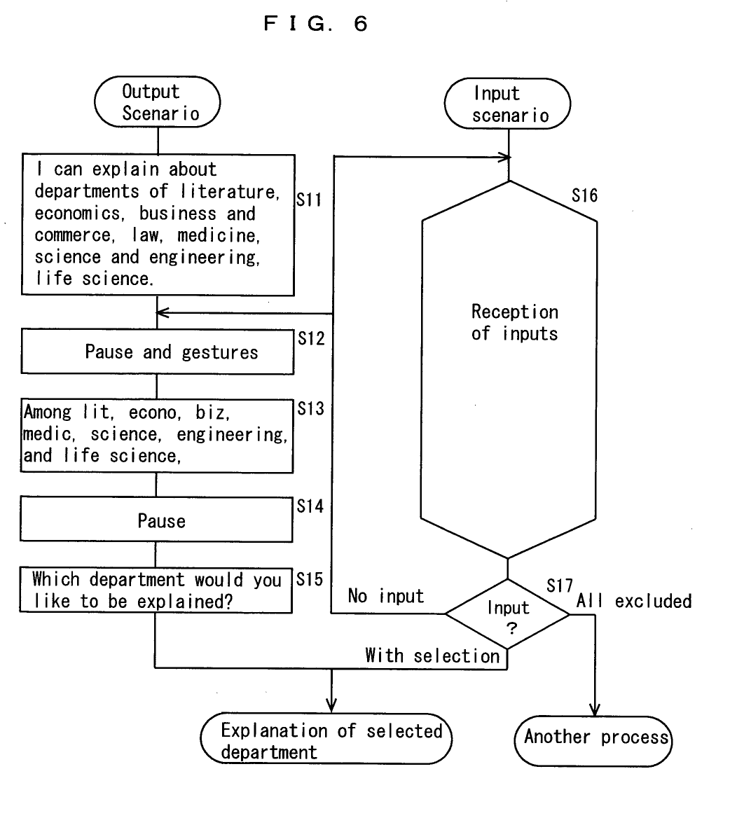

FIG. 6 shows a specific example of voice guidance taking department guidance in a university as an example. The specific example is applicable to any of the voice dialogue apparatus, the voice dialogue method, and the voice dialogue program according to the embodiment. In step 11, departments in the university are enumerated. In step 12, a pause is inserted while providing gestures of the robot body. In step 13, enumeration of the keywords is repeated. In this example, literature is abbreviated to “lit”, and economics is abbreviated to “econo”. That is, the keywords are converted into short keywords of synonymous terms, and the short keywords are enumerated in the same order. In step 14, a pause is inserted again, and in step 15, a sentence for prompting the person to input the answer is outputted.

An answer of “economics” or the like may be inputted at the time of step 11. In preparation for such voice input, in the input scenario, voice input is recognized from the keyword enumeration in step 11. Recognition of voice input may be started from the second keyword enumeration in step 13. In step 17, the routine proceeds to a process branched in accordance with the input result.

In the embodiment, the following advantages can be obtained.

(1) Since keywords are enumerated two or more times, it is not likely that a person fails to hear any of the keywords.

(2) In the first keyword enumeration, the person roughly understands the overall keywords, and in the second keyword enumeration, the person can hear the keyword correctly, and make an answer. Therefore, the correct answer can be made easily.

(3) Since the first keyword enumeration and the second keyword enumeration are carried out differently, the dialogue does not become monotonous.

(4) Since the sum of bits for each subject, the keywords include individual answers such as “literature” and “economics”, and answers indicating scopes such as “arts”, and “all”. In the presence of the input of “I don't need A, B, and C.”, by determining that the keywords other than A, B, and C are selected, it is possible to further expand the scope of the recognizable input.

1. A voice dialogue apparatus comprising:
a microphone for allowing voice input from a person;
a voice recognition apparatus for recognizing the voice input to the microphone;
a voice output apparatus having a speaker;
a memory for storing a scenario; and
a processing system for controlling the voice recognition apparatus and the voice output apparatus in accordance with the scenario, wherein
the scenario stored in the memory is configured such that, at the time of outputting voice from the speaker for enumerating a plurality of keywords, first enumerating the keywords, and then, enumerating the keywords next, pausing the voice output, again for receiving the voice input of the person.

2. The voice dialogue apparatus according to claim 1, wherein the scenario is further configured such that, when enumerating the keywords again, the keywords is enumerated in the same order as in the first enumeration, with converting at least one of the keywords into a synonymous term.

3. The voice dialogue apparatus according to claim 1, wherein the voice recognition apparatus is further configured such that the voice input from the person in response to the enumerated keywords is at the latest processed from when the keyword being again enumerated by the voice recognition apparatus.

4. A voice dialogue method comprising the steps of:
receiving voice input of a person from a microphone;
performing voice recognition of the voice input by a voice recognition apparatus; and
controlling the voice recognition apparatus and a voice output apparatus by a processing system, wherein
after a plurality of keywords are enumerated from a speaker, the voice output is paused, and then, the plurality of keywords are enumerated again, and the voice input of the person is recognized by the voice recognition apparatus.

5. A voice dialogue program for carrying out the steps of:
receiving voice input of a person from a microphone;
performing voice recognition of the voice input by a voice recognition apparatus; and
controlling the voice recognition apparatus and a voice output apparatus by a processing system, wherein the voice dialogue program comprising:
an instruction for enumerating a plurality of keywords from a speaker as a voice output;
an instruction for pausing the voice output;
an instruction for enumerating the keywords again; and
an instruction for recognizing the voice input of the person by the voice recognition apparatus at least at the time of enumerating the keywords again.
